(19) United States
(12) Patent Application Publication
(10) Pub. No.: US 2013/0237470 A1
(43) Pub. Date: Sep. 12, 2013

(54) DETERGENTS WITH ANTIMICROBIAL EFFECT

(71) Applicant: HENKEL AG & CO. KGAA, Duesseldorf (DE)

(72) Inventors: Dirk Bockmuehl, Wuppertal (DE); Martina Hutmacher, Duesseldorf (DE); Sabine Schuemann, Neuss (DE); Thorsten Ott, Moenchengladbach (DE); Ulrich Pegelow, Duesseldorf (DE)

(73) Assignee: Henkel AG & Co. KGaA, Duesseldorf (DE)

(21) Appl. No.: 13/870,211

(22) Filed: Apr. 25, 2013

Related U.S. Application Data
(63) Continuation of application No. PCT/EP2011/068402, filed on Oct. 21, 2011.

(30) Foreign Application Priority Data
Oct. 28, 2010 (DE) 10 2010 043 066.8

(51) Int. Cl. C11D 1/66; C11D 3/48

(52) U.S. Cl. CPC C11D 1/66; C11D 3/48
USPC 510/319

(57) ABSTRACT

A liquid washing or cleaning agent comprises: a biocidal quaternary ammonium compound; a potassium salt; and an alkoxylated oxo alcohol. A method of making a washing or cleaning agent comprises: neutralizing a composition comprising a biocidal quaternary ammonium compound and an alkoxylated oxo alcohol with potassium hydroxide; and producing the washing or cleaning agent from the composition, wherein the washing or cleaning agent has a pH in the range of 7.5 to 10.5.

### FIELD OF THE INVENTION

The present invention generally relates to a washing or cleaning agent encompassing a biocidal quaternary ammonium compound. The invention also relates to the use and to a method for producing such a washing or cleaning agent.

### BACKGROUND OF THE INVENTION

The adhesion of microorganisms to surfaces, especially in the case of pathogenic microorganisms, is undesirable. Adherent microorganisms frequently lead to infections or to reinfection in humans, animals and plants.

It is increasingly common for delicate textiles, such as silk or microfibers for example, to be made into items of clothing that can only be washed at 30 or 40° C. This does not reliably kill microorganisms.

Alongside the lower washing temperature, however, the use of liquid washing agents, which are generally free from bleaching agents, is also usual nowadays. In a 60° C. wash, which used to be the norm, virtually all germs would be reliably destroyed, on the one hand by the higher temperature and on the other by the bleaching agents contained in the all-purpose washing agents that were conventionally used.

Thus, owing to the change in washing behavior, textiles contaminated with viruses or bacteria cannot be sanitized to the necessary degree, resulting in some circumstances in (re)infection when the consumer comes into contact again with the supposedly clean laundry.

In addition, problems with unpleasant odors can also arise, because residual germs on the laundry can multiply during drying, wearing or storage and produce unpleasantly smelling metabolites. Furthermore, an unpleasant odor can be caused inside a washing machine itself due to adherent biofilms.

Compounds and compositions having an antimicrobial effect and their use in washing, cleaning, aftertreatment or washing auxiliary agents are known in the prior art. The compounds having an antimicrobial effect that are used are frequently quaternary ammonium compounds. Thus, for example, a textile treatment agent having a biocidal effect and containing didecyldimethylammonium chloride as a biocidal compound is known from WO 09/065,823 A1.

Washing agent formulations for cleaning textiles mostly contain anionic surfactants. The incorporation of quaternary ammonium compounds having an antimicrobial effect in such formulations leads to undesirable interactions between the anionic surfactants and the quaternary ammonium compounds.

Surprisingly, it has been found that not all matrices based on non-ionic surfactants are suitable as a matrix for a washing or cleaning agent having an antimicrobial effect and containing a quaternary ammonium compound. It has been found in particular that biocidal quaternary ammonium compounds cannot be stably incorporated into matrices based on alkoxylated fatty alcohols as non-ionic surfactants.

An object of this invention was therefore to provide a stable washing or cleaning agent having an antimicrobial effect and containing a quaternary ammonium compound as the antimicrobially active compound.

This object is achieved by a liquid washing or cleaning agent encompassing

a) a biocidal quaternary ammonium compound,
b) a potassium salt and
c) an alkoxylated oxo alcohol.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In an embodiment, a liquid washing or cleaning agent, comprises: a biocidal quaternary ammonium compound; a potassium salt; and an alkoxylated oxo alcohol.

In an embodiment, a method of forming a matrix of a liquid washing or cleaning agent, comprises: stabilizing a composition comprising a quaternary ammonium compound with a potassium salt; adding an alkoxylated oxo alcohol to the composition; and forming the matrix of the liquid washing or cleaning agent.

In an embodiment, a method of making a washing or cleaning agent, comprises: neutralizing a composition comprising a biocidal quaternary ammonium compound and an alkoxylated oxo alcohol with potassium hydroxide; and producing a washing or cleaning agent having a pH in the range of 7.5 to 10.5 from the composition.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Surprisingly, it has been found that through the use of alkoxylated oxo alcohols as non-ionic surfactants and KOH as a base, stable washing or cleaning agents having an antimicrobial effect can be obtained that contain a quaternary ammonium compound as the antimicrobially active compound.

It is preferable for the biocidal quaternary ammonium compound to be selected from the group consisting of alkyltrimethylammonium halides, dialkyldimethylammonium halides, benzalkonium salts, pyridinium salts and mixtures thereof. It is preferable, in particular, for the biocidal quaternary ammonium compound to be a dialkyldimethylammonium halide selected from the group consisting of di-n-decyldimethylammonium chloride, didecyldimethylammonium bromide, dioctyldimethylammonium chloride and mixtures thereof.

These biocidal quaternary ammonium compounds are effective against viruses, bacteria, molds or fungal yeasts that adhere to textiles.

It is furthermore preferable for the alkoxylated oxo alcohol to be an ethoxylated C₁₁ oxo alcohol, an ethoxylated C₁₃ oxo alcohol, an ethoxylated C₁₂-C₁₅ oxo alcohol, an ethoxylated C₁₃-C₁₅ oxo alcohol, ethoxylated C₁₄-C₁₅ oxo alcohol or a mixture of one or more of these ethoxylated oxo alcohols.

These alkoxylated oxo alcohols exhibit a particularly favorable foaming and wetting ability for use in a liquid washing or cleaning agent.

In a preferred embodiment the washing or cleaning agent has a pH in the range of 7.5 to 10.5.

A pH in this range leads to liquid washing or cleaning agents having a particularly good washing or cleaning performance.

It is also preferable for the washing or cleaning agent to further contain an amine oxide.

Surprisingly, it has been found that by adding an amine oxide, not only can the washing or cleaning performance of the liquid washing or cleaning agent on oil-based stains be improved, but also the stability of the washing or cleaning agent can be increased such that the matrix of the liquid washing or cleaning agent tolerates the presence of alkoxylated fatty alcohols. Correspondingly, in a preferred embodiment the liquid washing or cleaning agent contains, in addition to an amine oxide, up to 10 weight percent (wt. %) of alkoxylated fatty alcohol, relative to the total amount of liquid washing or cleaning agent.

In an alternative embodiment the washing agent is free from alkoxylated fatty alcohols.

It has moreover surprisingly been found that adding an amine oxide also allows optical brighteners to be stably incorporated into the liquid washing or cleaning agents. Correspondingly, in a further preferred embodiment the liquid washing or cleaning agent contains, in addition to an amine oxide, up to 2 wt. % of an optical brightener, relative to the total amount of liquid washing or cleaning agent.

It is furthermore preferable for the washing or cleaning agent moreover to contain a boric acid and/or boron salt.

Surprisingly, it has been found that washing or cleaning agents have a higher antimicrobial performance, in particular towards fungi, than otherwise identical washing or cleaning agents without the addition of boric acid and/or boron salt.

The invention also relates to the use of a washing or cleaning agent according to the invention in the washing, cleaning and/or pretreatment of textile fabrics.

The invention furthermore relates to the use of a combination of a potassium salt and an alkoxylated oxo alcohol to stabilize a quaternary ammonium compound in the matrix of a liquid washing or cleaning agent.

The invention also provides a method for producing a washing or cleaning agent having a pH in the range of 7.5 to 10.5, encompassing a biocidal quaternary ammonium compound and an alkoxylated oxo alcohol, in which KOH is used for pH adjustment and/or acid neutralization.

The invention is explained in more detail below, by reference, inter alia, to examples.

The washing or cleaning agent contains a biocidal quaternary ammonium compound, a potassium salt and an alkoxylated oxo alcohol.

As a primary constituent, the liquid washing or cleaning agent contains a quaternary ammonium compound having a biocidal effect. The quaternary ammonium compounds (QACs) that are suitable as biocidal active ingredients have the general formula (R¹)(R²)(R³)(R⁴)N⁺X⁻, in which R¹ to R⁴ are identical or different C₁-C₂₂ alkyl residues, C₇-C₂₈ aralkyl residues or heterocyclic residues, wherein two, or in the case of an aromatic bonding as in pyridine, even three, residues together with the nitrogen atom form the heterocycle, for example a pyridinium or imidazolinium compound, and X⁻ are halide ions, sulfate ions, hydroxide ions or similar anions.

QACs can be produced by reacting tertiary amines with alkylating agents, such as, for example, methyl chloride, benzyl chloride, dimethyl sulfate, dodecyl bromide, and also ethylene oxide. The alkylation of tertiary amines having one long alkyl residue and two methyl groups is achieved particularly easily; in addition, the quaternization of tertiary amines having two long residues and one methyl group can be performed under gentle conditions with the aid of methyl chloride. Amines having three long alkyl residues or hydroxy-substituted alkyl residues are not very reactive and are preferably quaternized with dimethyl sulfate.

Suitable QACs are, for example, benzalkonium chloride (N-alkyl-N,N-dimethylbenzylammonium chloride, CAS No. 8001-54-5), benzalkon B (m,p-dichlorobenzyldimethyl-C₁₂-alkylammonium chloride, CAS No. 58390-78-6), benzoxonium chloride (benzyldodecyl bis-(2-hydroxyethyl)ammonium chloride), cetrimonium bromide (N-hexadecyl-N,N,N-trimethylammonium bromide, CAS No. 57-09-0), benzethonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as didecyldimethylammonium chloride (CAS No. 7173-51-5), didecyldimethylammonium bromide (CAS No. 2390-68-3), dioctyldimethylammonium chloride, 1-cetylpyridinium chloride (CAS No. 123-03-5) and thiazolium iodides and mixtures thereof.

Particularly preferred QACs are dialkyldimethylammonium chlorides, in particular didecyldimethylammonium chloride, N-octadecyl-N,N,N-trimethylammonium chloride, N-hexadecyl-N,N,N-trimethylammonium chloride and the benzalkonium chlorides having C₈-C₁₈ alkyl residues, in particular C₁₂-C₁₄ alkylbenzyldimethylammonium chloride. A further preferred biocidal compound is methyl-N-(2-hydroxyethyl)-N,N-di(caproyloxyethyl)ammonium methosulfate. Aside from the fact that these biocidal compounds are effective against numerous microorganisms, the cationic compounds attach particularly well to cotton-containing fabrics and blended fabrics.

Dialkyldimethylammonium halides, benzalkonium halides and/or substituted benzalkonium halides are commercially available for example as Bardac® or Barquat® from Lonza, Marquat® from Mason, Variquat® from Evonik Industries and Hyamine® from Lonza.

The biocidal quaternary ammonium compound is used in an amount of 0.1 wt. % to 20 wt. %, preferably 0.5 wt. % to 10 wt. % and particularly preferably 1 wt. % to 5 wt. %, relative in each case to the total amount of liquid washing or cleaning agent. From a toxicological and ecological perspective it is preferable in particular for the amount of biocidal quaternary ammonium compound to be less than 3 wt. %.

As a further constituent, the liquid washing or cleaning agent contains an alkoxylated oxo alcohol.

Oxo alcohols are primary, in some cases branched, higher alcohols, which are obtained by oxo synthesis. In this process oxo aldehydes are first produced by hydroformylation and then converted into the corresponding oxo alcohols by catalytic hydrogenation.

The alkoxylated oxo alcohols are preferably ethoxylated and/or propoxylated, with ethoxylated oxo alcohols being preferably used. It is preferable in particular for the ethoxylated oxo alcohol to be an ethoxylated C₁₁ oxo alcohol, an ethoxylated C₁₃ oxo alcohol, an ethoxylated C₁₂-C₁₅ oxo alcohol, an ethoxylated C₁₃-C₁₅ oxo alcohol, ethoxylated C₁₄-C₁₅ oxo alcohol or a mixture of one or more of these ethoxylated oxo alcohols.

The degree of ethoxylation is preferably 3 EO, 4 EO, 5 EO, 6 EO, 7 EO, 8 EO, 10 EO, 11 EO or 30 EO. The specified degrees of ethoxylation are statistical averages which for an individual product can be a whole number or a fraction.

The alkoxylated oxo alcohol that is used is most particularly preferably an ethoxylated C₁₃-C₁₅ oxo alcohol having 7 EO.

The content of alkoxylated oxo alcohols in the liquid washing or cleaning agent is preferably 1 to 17 wt. %, by preference 2 to 12 wt. % and in particular 3 to 10 wt. %, relative in each case to the total liquid washing or cleaning agent.

As a further constituent, the liquid washing or cleaning agent contains a potassium salt. The liquid washing or cleaning agent contains at least one potassium salt because potassium hydroxide (KOH) is used in place of sodium hydroxide (NaOH) to adjust the pH and/or to neutralize acid components, such as for example citric acid, boric acid or phosphonic acid.

The liquid washing or cleaning agent preferably contains potassium citrate and/or potassium borate as the potassium salt.

In addition to the three constituents previously described, the washing or cleaning agent can contain further ingredients, which further improve the application-related and/or aesthetic properties of the washing or cleaning agent. In the context of the present invention the washing or cleaning agent preferably additionally contains one or more substances from the group of non-ionic surfactants, builders, bleaching agents, bleach catalysts, bleach activators, enzymes, electrolytes, non-aqueous solvents, pH adjusters, perfume compositions, perfume carriers, fluorescent agents, dyes, hydrotropes, foam inhibitors, silicone oils, soil release polymers, graying inhibitors, anti-shrink agents, anti-crease agents, dye transfer inhibitors, further antimicrobial active ingredients, germicides, fungicides, antioxidants, preservatives, corrosion inhibitors, antistatics, bittering agents, ironing aids, phobing and impregnating agents, non-swelling and anti-slip agents, softening components and UV absorbers.

Particularly preferred additional ingredients are non-ionic surfactants, builders, enzymes, electrolytes, non-aqueous solvents, pH adjusters, perfume compositions, fluorescent agents, dyes, hydrotropes, foam inhibitors, soil release polymers, preservatives, graying inhibitors, dye transfer inhibitors, UV absorbers and mixtures thereof.

A particularly preferred further ingredient is an amine oxide.

Amine oxides belong to the group of non-ionic surfactants, and amine oxides that can preferably be used are for example N-cocoalkyl-N,N-dimethyl amine oxide, N-tallow alkyl-N,N-dihydroxyethyl amine oxide, myristylcetyldimethyl amine oxide or lauryldimethyl amine oxide. The amount of amine oxide is preferably up to 5 wt. %, more preferably between 0.5 and 3 wt. % and particularly preferably between 1 and 2 wt. %, relative in each case to the total amount of liquid washing or cleaning agent.

An advantage of using an amine oxide is that the presence of the amine oxide stabilizes the liquid matrix of the washing or cleaning agent such that the presence of alkoxylated fatty alcohols is tolerated.

Correspondingly, in a preferred embodiment the liquid washing or cleaning agent contains, in addition to an amine oxide, up to 10 wt. %, relative to the total amount of liquid washing or cleaning agent, of an ethoxylated fatty alcohol.

In particular, primary alcohols having preferably 8 to 18 carbon (C) atoms and on average 1 to 12 mol of ethylene oxide (EO) per mol of alcohol are used as alkoxylated fatty alcohols. However, alcohol ethoxylates having linear residues obtained from alcohols of native origin having 12 to 18 C atoms, for example, from coconut alcohol, palm alcohol, tallow fatty alcohol or oleyl alcohol, and on average 2 to 8 EO per mol of alcohol are preferred in particular. The preferred ethoxylated alcohols include for example C₁₂₋₁₄ alcohols having 3 EO, 4 EO or 7 EO, C₁₂₋₁₈ alcohols having 3 EO, 5 EO or 7 BO and mixtures thereof. The specified degrees of ethoxylation are statistical averages which for an individual product can be a whole number or a fraction. Preferred alcohol ethoxylates have a narrow homolog distribution (narrow range ethoxylates, NRE). In addition to these non-ionic surfactants, fatty alcohols having more than 12 EO can also be used. Examples thereof are tallow fatty alcohol having 14 EO, 25 EO, 30 EO or 40 EO. Alkoxylated fatty alcohols containing EO and PO groups together in the molecule can also be used according to the invention. Also suitable moreover are a mixture of a (highly) branched ethoxylated fatty alcohol and an unbranched ethoxylated fatty alcohol, such as for example a mixture of a C₁₆₋₁₈ fatty alcohol having 7 EO and 2-propyl heptanol having 7 EO. The washing or cleaning agent preferably contains in particular a C₁₂₋₁₈ fatty alcohol having 7 EO as the alkoxylated fatty alcohol.

In an alternative embodiment the liquid washing or cleaning agent is free from alkoxylated fatty alcohols, as these lead to a slight cloudiness of the liquid washing or cleaning agent and hence to a product that for some users is less aesthetically attractive.

A further advantage of using an amine oxide is that the presence of the amine oxide stabilizes the liquid matrix of the washing or cleaning agent such that optical brighteners can be incorporated.

Correspondingly, in a preferred embodiment the liquid washing or cleaning agent contains, in addition to an amine oxide, up to 2 wt. %, relative to the total amount of liquid washing or cleaning agent, of an optical brightener.

Suitable optical brighteners encompass for example compounds from the classes of bis-styrene benzenes, stilbenes, benzoxazoles, coumarins, pyrenes and naphthalenes. Commercial optical brighteners are sold under the brands Tinopal®, Uvitex® (both from Ciba Speciality Chemicals), Ultraphor® (BASF SE) and Blankophor® (Bayer).

Particularly preferred optical brighteners encompass disodium-4,4′-bis-(2-morpholino-4-anilino-s-triazin-6-ylamino)stilbene disulfonate, disodium-2,2′-bis-(phenylstyryl)disulfonate, 4,4′-bis[(4-anilino-6-[bis(2-hydroxyethy)amino]-1,3,5-triazin-2-yl)amino]stilbene-2,2′-disulfonic acid, hexasodium-2,2′-[vinylene bis[(3-sulfonato-4,1-phenylene)imino[6-(diethylamino)-1,3,5-triazine-4,2-diyl]imino]]bis-(benzene-1,4-disulfonate), 2,2′-(2,5-thiophenediyl)bis[5-1,1-dimethylethyl)benzoxazole, 4-methyl-7-(diethylamino)coumarin and/or 2,5-bis(benzoxazol-2-yl)thiophene.

A further preferred ingredient is boric acid or a boric acid salt. If the liquid washing or cleaning agent contains a boric acid salt, it is particularly preferable for it to be a potassium salt, such as potassium borate. Adding boric acid or a boric acid salt leads to an increase in the antimicrobial performance of the liquid washing or cleaning agent. In particular, the antimicrobial performance against fungi is increased, with a particular increase in performance with respect to Candida albicans being observed.

The washing or cleaning agents according to the invention preferably contain water as the main solvent.

The production of a washing or cleaning agent according to the invention takes place by means of conventional and known methods and processes. Thus, for example, the constituents of the washing or cleaning agent can simply be mixed together in stirred-tank reactors, with water, the acid components, if present, such as for example citric acid, boric acid, phosphonic acid, etc., and the alkoxylated oxo alcohols being introduced as convenient. The non-aqueous solvents, if present, are conveniently added at this time too, although the addition can also take place at a later time. Then the acid components are neutralized with KOH and the biocidal quaternary ammonium compound is added. The further constituents are then added, preferably in portions. If the washing or cleaning agent additionally contains a thickener, this is dissolved in water and pre-swelled at the very start of the process and then the acid components and the alkoxylated oxo alcohols are added to this mixture.

### EXAMPLES

The compositions of six comparison recipes C1 to C6 and the compositions of two washing or cleaning agents according to the invention, E1 and E2, are shown in Table 1 (all amounts are given in wt. % of active substance, relative to the composition):

TABLE 1

| | C1 | C2 | C3 | C4 | C5 | C6 | E1 | E2 |
|---|---|---|---|---|---|---|---|---|
| C₁₂₋₁₈ fatty alcohol | 9 | — | 9 | 9 | 4.5 | 4.5 | — | 4.5 |
| having 7 EO | | | | | | | | |
| C₁₃₋₁₅ oxo alcohol | — | 9 | — | — | 4.5 | 4.5 | 9 | 4.5 |
| having 7 EO | | | | | | | | |
| C₁₂₋₁₄ alkyldimethyl | — | — | — | 2 | — | — | — | 2 |
| amine oxide | | | | | | | | |
| Didecyldimethylammonium | 2.5 | 2.5 | 2.5 | 2.5 | 2.5 | 2.5 | 2.5 | 2.5 |
| chloride | | | | | | | | |
| Citric acid | 2 | 2 | 2 | 2 | 2 | 2 | 2 | 2 |
| Boric acid | 0.6 | 0.6 | 0.6 | 0.6 | 0.6 | 0.6 | 0.6 | 0.6 |
| Phosphonic acid | 0.1 | 0.1 | 0.1 | 0.1 | 0.1 | 0.1 | 0.1 | 0.5 |
| Preservative* | 0.1 | 0.1 | 0.1 | 0.1 | 0.1 | 0.1 | 0.1 | 0.1 |
| Non-aqueous solvents | 5 | 5 | 5 | 5 | 5 | 5 | 5 | 10 |
| Xanthan | 0.3 | 0.3 | 0.3 | 0.3 | 0.3 | 0.3 | 0.3 | 0.3 |
| Enzymes (amylase & | 0.5 | 0.5 | 0.5 | 0.5 | 0.5 | 0.5 | 0.5 | 0.8 |
| protease) | | | | | | | | |
| Perfume | 0.4 | 0.4 | 0.4 | 0.4 | 0.4 | 0.4 | 0.4 | 1.00 |
| Dyes, defoaming agents | 0.25 | 0.25 | 0.25 | 0.25 | 0.25 | 0.25 | 0.25 | 0.25 |
| Water | to 100 | to 100 | to 100 | to 100 | to 100 | to 100 | to 100 | to 100 |
| KOH up to pH | — | — | 8.4 | — | — | 8.4 | 8.4 | 8.4 |
| NaOH up to pH | 8.4 | 8.4 | — | 8.4 | 8.4 | — | — | — |
| Appearance | PS | PS | PS | PS | PS | PS | S, | S, |
| | | | | | | | clear | slightly |
| | | | | | | | | cloudy |

PS = phase separation
S = stable
*Aqueous formulation consisting of tetramethylol glycoluril, 2-methyl-2H-isothiazol-3-one and 2-octyl-4-isothiazolin-3-one (approximately 15 wt. % active substances)

The results clearly show that stable, liquid washing or cleaning agents having an antimicrobial effect are obtained only when an alkoxylated oxo alcohol in combination with KOH is used as the base. By adding an amine oxide the liquid matrix can be stabilized such that an alkoxylated fatty alcohol can additionally be present in the liquid matrix.

The fungicidal and bactericidal effect of the washing and cleaning agents according to the invention, E1 and E2, was determined by means of disinfectant tests based on EN 1276:2009 and EN 1650:2008.

The bactericidal effectiveness of the washing or cleaning agents E1 and E2 was determined in respect of Staphylococcus aureus and Pseudomonas aeruginosa and the fungicidal effectiveness in respect of Candida albicans. Under the tested conditions (concentration of agent 0.5 and 1 wt. %, contact time: 60 minutes, temperature: 20° C.), a reduction in the bacterial count by a factor of at least 10⁵ was observed in the test of bactericidal effectiveness and by a factor of at least 10⁴ in the test of fungicidal effectiveness.

The compositions of two comparison recipes C7 and C8 and the compositions of three washing or cleaning agents according to the invention, E3 to E5, are shown in Table 2 (all amounts are given in wt. % of active substance, relative to the composition):

TABLE 2

| | C7 | C8 | E3 | E4 | E5 |
|---|---|---|---|---|---|
| C₁₂₋₁₈ fatty alcohol having 7 EO | — | — | — | — | 4.5 |
| C₁₃₋₁₅ oxo alcohol having 7 EO | 9 | 9 | 9 | 9 | 4.5 |
| C₁₂₋₁₄ alkyldimethyl amine oxide | — | — | 2 | 2 | 2 |
| Didecyldimethylammonium | 2.5 | 2.5 | 2.5 | 2.5 | 2.5 |
| chloride | | | | | |
| Citric acid | 2 | 2 | 2 | 2 | 2 |
| Boric acid | 0.6 | 0.6 | 0.6 | 0.6 | 0.6 |
| Phosphonic acid | 0.1 | 0.1 | 0.1 | 0.1 | 0.5 |
| Preservative* | 0.1 | 0.1 | 0.1 | 0.1 | 0.1 |
| Non-aqueous solvents | 5 | 5 | 5 | 5 | 10 |
| Optical brightener 1 | 0.035 | — | 0.035 | — | 0.035 |
| Optical brightener 2 | — | 0.035 | — | 0.035 | — |
| Xanthan | 0.3 | 0.3 | 0.3 | 0.3 | 0.3 |
| Enzymes (amylase & protease) | 0.5 | 0.5 | 0.5 | 0.5 | 0.8 |
| Perfume | 0.4 | 0.4 | 0.4 | 0.4 | 1.00 |
| Dyes, defoaming agents | 0.25 | 0.25 | 0.25 | 0.25 | 0.25 |
| Water | to | to | to | to | to 100 |
| | 100 | 100 | 100 | 100 | |
| KOH up to pH | 8.4 | 8.4 | 8.4 | 8.4 | 8.4 |
| Appearance | PS | PS | S | S | S |

PS = phase separation
S = stable
*Aqueous formulation consisting of tetramethylol glycoluril, 2-methyl-2H-isothiazol-3-one and 2-octyl-4-isothiazolin-3-one (approx. 15 wt. % active substances)
Optical brightener 1 = disodium salt of 4,4′-bis(2-sulfostyryl)biphenyl (for example Tinopal ® CBS-X from Ciba)
Optical brightener 2 = 4-methyl-7-(diethylamino)coumarin (for example Tinopal ® SWN from Ciba)

The fungicidal and bactericidal effect of the washing and cleaning agents according to the invention, E3 to E5, was demonstrated by means of disinfectant tests based on EN 1276:2009 and EN 1650:2008.

The results show that optical brighteners can be stably incorporated into liquid washing or cleaning agents containing a biocidal quaternary ammonium compound by adding an amine oxide.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid washing or cleaning agent, comprising:
a biocidal quaternary ammonium compound;
a potassium salt; and
an alkoxylated oxo alcohol.

2. The liquid washing or cleaning agent of claim 1, wherein the biocidal quaternary ammonium compound is selected from the group consisting of alkyltrimethylammonium halides, dialkyldimethylammonium halides, benzalkonium salts, pyridinium salts and mixtures thereof.

3. The liquid washing or cleaning agent of claim 2, wherein the biocidal quaternary ammonium compound is a dialkyldimethylammonium halide selected from the group consisting of didecyldimethylammonium chloride, didecyldimethylammonium bromide, dioctyldimethylammonium chloride and mixtures thereof.

4. The liquid washing or cleaning agent of claim 1, wherein the alkoxylated oxo alcohol is an ethoxylated C₁₁ oxo alcohol, an ethoxylated C₁₃ oxo alcohol, an ethoxylated C₁₂-C₁₅ oxo alcohol, an ethoxylated C₁₃-C₁₅ oxo alcohol, ethoxylated C₁₄-C₁₅ oxo alcohol or a mixture of one or more of these ethoxylated oxo alcohols.

5. The liquid washing or cleaning agent of claim 1, wherein the washing or cleaning agent has a pH in the range of 7.5 to 10.5.

6. The liquid washing or cleaning agent of claim 1, wherein the washing or cleaning agent further comprises an amine oxide.

7. The liquid washing or cleaning agent of claim 6, wherein the washing or cleaning agent further comprises up to 10 wt. % of an alkoxylated fatty alcohol, relative to the total amount of liquid washing or cleaning agent.

8. The liquid washing or cleaning agent of claim 6, wherein the washing or cleaning agent further comprises up to 2 wt. % of an optical brightener, relative to the total amount of liquid washing or cleaning agent.

9. The liquid washing or cleaning agent of claim 1, wherein the washing or cleaning agent is free from alkoxylated fatty alcohols.

10. The liquid washing or cleaning agent of claim 1, wherein the washing or cleaning agent further comprises a boric acid and/or boron salt.

11. A method of forming a matrix of a liquid washing or cleaning agent, comprising:
stabilizing a composition comprising a quaternary ammonium compound with a potassium salt;
adding an alkoxylated oxo alcohol to the composition; and
forming the matrix of the liquid washing or cleaning agent.

12. A method of making a washing or cleaning agent, comprising:
neutralizing a composition comprising a biocidal quaternary ammonium compound and an alkoxylated oxo alcohol with potassium hydroxide; and
producing the washing or cleaning agent from the composition, wherein the washing or cleaning agent has a pH in the range of 7.5 to 10.5.

13. The method of claim 12, further comprising washing, cleaning, and/or conditioning textile fabrics with the composition.
